(19) United States
(12) Patent Application Publication
(10) Pub. No.: US 2002/0118670 A1
(43) Pub. Date: Aug. 29, 2002

(54) PACKET AND CIRCUIT SWITCHED COMMUNICATION IN A MOBILE COMMUNICATIONS NETWORK

(76) Inventor: HANNU KARI, VEIKKOLA (FI)

Correspondence Address: DAVID W. LYNCH, ALTERA LAW GROUP, 6500 CITY WEST PARKWAY, SUITE 100, MINNEAPOLIS, MN, 55344-7701, US

(21) Appl. No.: 09/125,133

(22) PCT Filed: Dec. 15, 1997
(86) PCT No.: PCT/FI97/00785

(30) Foreign Application Priority Data
Dec. 16, 1996 (FI) 965049

(51) Int. Cl. H04L 12/66

(52) U.S. Cl. 370/352

(57) ABSTRACT

An arrangement for establishing a packet switched and a circuit switched connection between a first telecommunications system (NSS) and a second telecommunications system (WAN) comprises: 1) a packet switched converter (PSDC) for establishing a packet switched connection towards the first telecommunications system (NSS) and 2) a circuit switched converter (CSDC) for establishing a circuit switched connection towards the first telecommunications system (NSS). According to the invention, the arrangement also comprises a common data communications controller (CDCC) for establishing a connection between said converters (PSDC, CSDC) and said second telecommunications system (WAN). The interface of the common controller (CDCC) towards the second telecommunications system (WAN) is independent of its interface towards the first telecommunications system (NSS). For eliminating overlapping functions it is advantageous for the common controller (CDCC) to be adapted to perform as many as possible of the functions performed by the arrangement.

### BACKGROUND OF THE INVENTION

The invention relates to an arrangement for implementing packet and circuit switched communication in a mobile communications network.

FIG. 1 shows the parts of a cellular mobile communications system which are relevant to the invention. Mobile stations MS communicate with base transceiver stations BTS over an air interface Um. The base transceiver stations are controlled by base station controllers BSC associated with mobile services switching centres MSC. A subsystem administered by a base station controller BSC—including the base transceiver stations BTS controlled by it—is commonly called a base station subsystem BSS. The interface between a mobile services switching centre MSC and a base station subsystem BSS is called an A-interface. The part of the mobile communications system on the MSC side of the A-interface is called a Network Subsystem NSS. Correspondingly, the interface between a base station controller BSC and a base transceiver station BTS is called an Abis-interface. A mobile services switching centre MSC switches incoming and outgoing calls. It performs similar functions as an exchange in a public switched telephone network PSTN. Additionally, it performs functions characteristic of mobile telecommunication only, such as subscriber location administration, in co-operation with network subscriber registers (not separately shown in FIG. 1).

A conventional radio connection used in digital mobile communications systems is circuit switched, i.e. radio resources allocated to a subscriber are reserved for the connection in question for the entire duration of the call. GPRS (General Packet Radio Service) is a new service designed for digital mobile communications systems, such as the GSM system. Packet radio service is described in ETSI (European Telecommunication Standard Institute) recommendation TC-TR-GSM 01.60. By means of packet radio service, a mobile station MS user can be provided with a packet switched radio connection which utilises radio resources in an efficient manner. In a packet switched connection, radio resources are reserved only when there is speech or data to be sent. Speech or data are assembled into packets with a predetermined length. When such a packet has been sent over the air interface Um, and the sending party does not immediately have a next packet to send, the radio resource can be released to be used by other subscribers. This kind of resource sharing is thus different from time division multiple access (TDMA), wherein the same physical channel is shared by several users in predetermined time slots.

Conventional cellular mobile communications systems, such as the GSM system, or its derivative, DCS, support only circuit switched connections. As shown in FIG. 1, a packet switched connection can be implemented e.g. by connecting a specific terminal server to a direct data access (DDA) interface of an MSC.

FIG. 1 also shows a GPRS support node GSN, which controls the operations of the packet radio service on the network side. The controlling comprises for example logging on and off the system by a mobile station (logon and logoff, respectively), routing area updating of a mobile station, and routing of data packets to the correct destination. A GSN node can be co-located with a base station controller BSC or a mobile switching centre MSC, or it can be located apart from them. The interface between the GSN node and the base station controller BSC is called a Gb-interface.

An adapter, or a GSM-LAN interconnection unit (GLIU), is e.g. a terminal server, such as a router, having several V.24 serial interfaces towards the MSC for protocols like SLIP (Serial Line Interface Protocol) or PPP (Point to Point Protocol), and a local area network (LAN) connection, such as Ethernet, towards the operator's LAN.

The GPRS support node GSN and the adapter GLIU comprise several similar parts, and they perform many similar functions. Both of them comprise an interface to the local area network, and their functions include substantially similar conversions between different protocols. Likewise, they both perform different security checks and/or data compression and decompression.

In the arrangement according to FIG. 1, in the uplink direction the adapter GLIU converts, or adapts, a circuit switched data stream into data packets, and in the downlink direction it converts data packets into a circuit switched data stream. Occasionally, functions independent of the communications mechanism, such as data decompression, decryption and/or packet routing, must be performed on the data packets. Control packets are handled locally in the particular node. In the downlink direction, the adapter GLIU performs reverse operations, such as encryption and compression, etc.

The GPRS support node GSN performs functions almost similar to those performed by the adapter GLIU. However, instead of data arriving as single characters, data arrive in packets. A packet can be a complete frame or a part thereof. On a packet switched connection, a resource is not reserved permanently. When a complete packet has been received, the process is substantially similar to the one performed by the GLIU.

On a circuit switched connection as well—i.e. via the GLIU—data propagate over the air interface Um in packets, but the sender sends each character separately. The mobile station comprises a protocol layer which assembles consecutive characters and sends them as packets. For the GSM system, it is irrelevant whether the characters to be sent in one go belong to the same frame or not.

The primary purpose of a circuit switched and a packet switched network is to send data packets, such as TCP/IP packets, from a terminal equipment to a wide area network WAN. In a GSM/GPRS system, resource reservation in a circuit switched network is different from that in a packet switched network.

Typically, the following functions are assigned to the GPRS support node GSN and the adapter GLIU:

TABLE 1

| | |
|---|---|
| 1. | packet assembly and disassembly |
| 2. | local handling of control packets |
| 3. | encryption and decryption |
| 4. | data compression and decompression |
| 5. | routing of packets |
| 6. | necessary security checks |
| 7. | access control |
| 8. | maintaining statistics |
| 9. | assembling billing data and transferring same to a billing system. |

A problem in the prior art implementation described above is the increased system cost and complexity resulting from similar functions being performed at two points of the system. Further, the prior art implementation is difficult to maintain, as changes have to be made in two different network elements simultaneously.

### BRIEF SUMMARY OF THE INVENTION

It is an object of the invention to provide an arrangement that solves the above problems relating to overlapping and complex network elements. The object of the invention is achieved with systems comprising the characteristic features of the attached independent claims. The preferred embodiments of the invention are disclosed in the dependent claims.

The invention is based on the idea that the system comprises a common telecommunications controller via which data packets to be transmitted on circuit switched connections and packet switched connections are conveyed. A simpler construction is achieved by concentrating the overlapping functions in a common telecommunications controller. The cost of the system will also be lowered and its maintenance will be facilitated. A common telecommunications controller requires fewer software and hardware interfaces than two separate adapters do. It will be simpler to add new line and network protocols, because the additions bring about changes in a single network element only. Further, the inventive arrangement simplifies the demarcation of responsibilities between different network elements and their suppliers.

### BRIEF DESCRIPTION OF THE DRAWINGS

The invention will now be described in more detail with reference to the preferred embodiments illustrated in the accompanying drawings, wherein:

FIG. 1 shows the parts of a mobile communications system which are relevant to the invention; and

FIG. 2 shows an arrangement according to the invention.

### DETAILED DESCRIPTION OF THE INVENTION

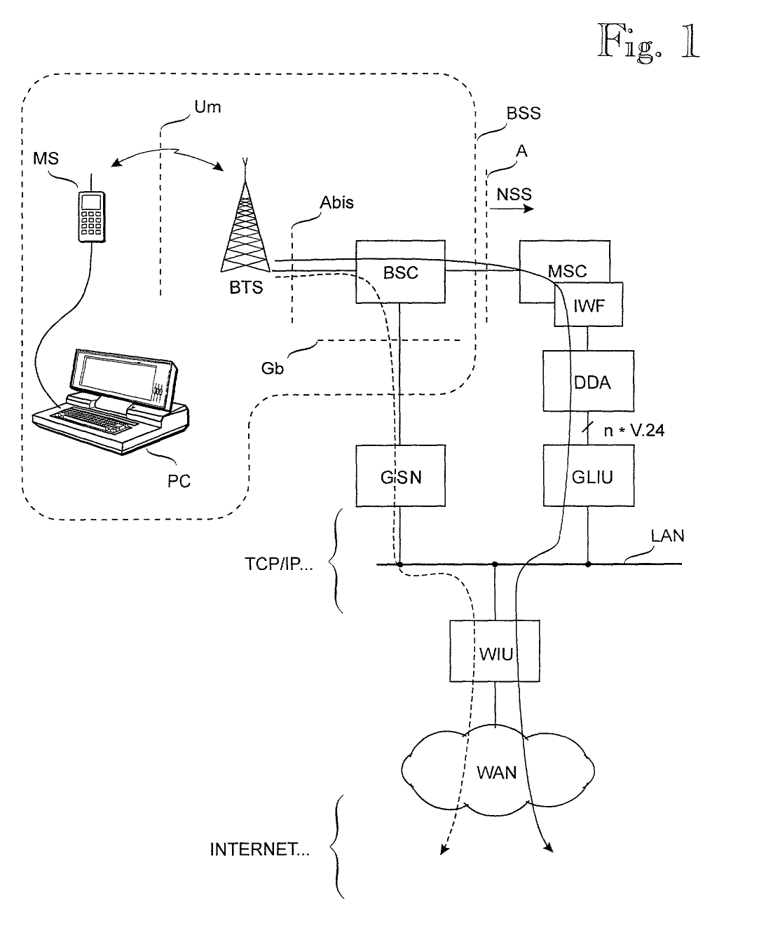

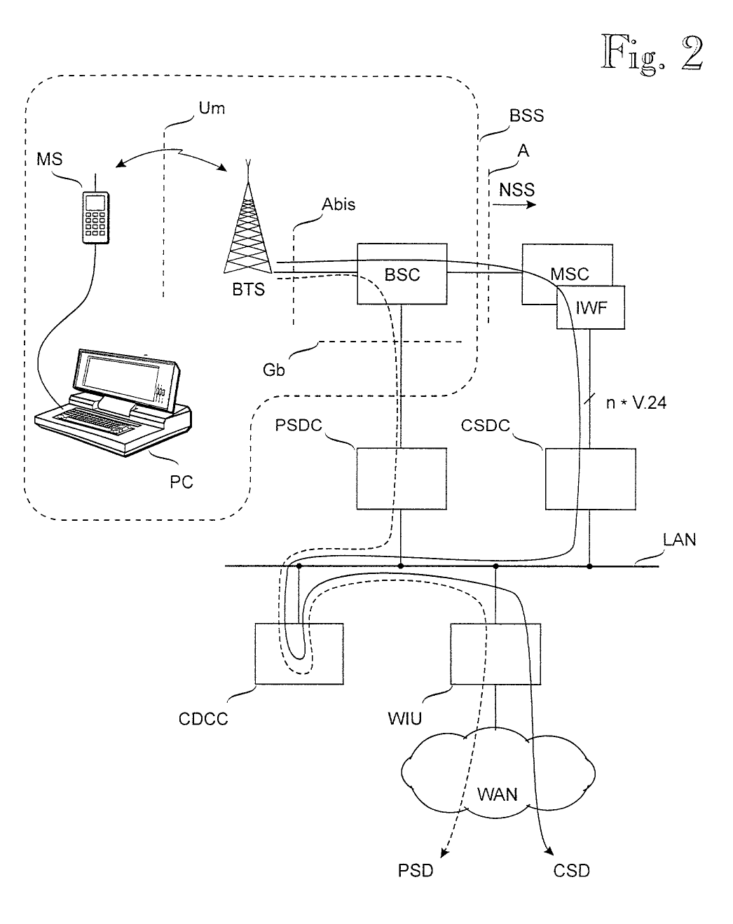

Referring now to FIG. 2, a common (data) communications controller CDCC controls substantially all communications on circuit switched and packet switched connections. In an arrangement according to the invention, the controller CDCC performs most of the functions performed by the GPRS support node GSN and the adapter GLIU in the prior art solution shown in FIG. 1.

Functions 1 and 2 of Table 1 are specific to both circuit and packet switched traffic. Additionally, for example in the GSM system, function 3 has already been implemented on the connection between a mobile station MS and a base transceiver station BTS. Functions 4 to 9 of Table 1, on the other hand, can be performed by the common data communications controller CDCC.

In addition to the common data communications controller CDCC, only two simple protocol converters are needed. A circuit switched data converter CSDC performs the necessary protocol conversions between the local area network LAN and the circuit switched network, the latter being shown in FIG. 2 as an MSC and an Interworking Function IWF. Correspondingly, a packet switched data converter PSDC performs the necessary protocol conversions between the local area network LAN and the packet switched network. In the implementation according to FIG. 2, a packet switched network is connected from the operator's local area network LAN directly to a base station controller BSC.

The functions of the converters PSDC and CSDC substantially consist of packet assembly and disassembly, and in the case of the PSDC, functions 2 and 3 of Table 1. The other functions mentioned in Table 1 can be concentrated in the common controller CDCC.

Thus, the arrangement for establishing a packet and circuit switched connection between a first telecommunications system NSS and a second telecommunications system WAN comprises: 1) a packet switched data converter PSDC for establishing a packet switched connection towards the first telecommunications system NSS and 2) a circuit switched data converter CSDC for establishing a circuit switched connection towards the first telecommunications system NSS. According to the invention, the arrangement also comprises a common data communications controller CDCC for establishing a connection between the converters PSDC, CSDC and the second telecommunications system WAN. The interface of the common communications controller CDCC towards the second telecommunications system WAN is independent of its interface towards the first telecommunications system NSS. This idea can also be expressed by stating that the converters PSDC and CSDC are independent of the second telecommunications system WAN. Only the common communications controller CDCC has to be able to interpret the protocols used in the WAN, which means that the controller CDCC is the only network element which must be upgraded if new network protocols and/or services are added.

For eliminating overlapping functions it is advantageous for the common communications controller CDCC to be adapted to perform as many as possible of the functions performed by the arrangement. It is especially advantageous to concentrate in the common communications controller CDCC most—preferably substantially all—functions which require logic going beyond simple protocol conversion. The functions requiring such logic include:

data compression and decompression

routing of packets

security checks

access control

maintaining statistics

assembling billing data and transferring same to a billing system.

FIG. 2 shows, by way of example, the converters PSDC and CSDC connected to the common communications controller CDCC by the operator's local area network LAN. LAN technology is well understood, and complete hardware components and interface software are readily available in the field. Alternatively, the common communications controller CDCC and the converters PSDC and CSDC can be integrated into one entity which performs substantially all the functions mentioned in Table 1. The parts CDCC, PSDC and CSDC of this entity are interconnected by means of a widely used or, alternatively, a proprietary parallel or serial interface. It is also conceivable to install in the controller CDCC two different interfaces for the converters PSDC and CSDC.

Physically, the common communications controller CDCC can be implemented as a commercially available router, the software of which is adapted to each telecommunications system such that the router and its software can perform at least functions 4 to 9 of Table 1.The common communications controller CDCC can also be a general purpose or a customised computer including the necessary interfaces and software.

It will be obvious to a person skilled in the art that as the technology advances, the basic idea of the invention can be implemented in many different ways. The invention and its embodiments are therefore not limited to the examples described above, but they can be varied within the scope of the claims.

1. An arrangement for establishing a packet switched connection and a circuit switched connection between a first telecommunications system (NSS) and a second telecommunications system (WAN), said arrangement comprising:
a packet switched converter (PSDC) for establishing a packet switched connection towards the first telecommunications system (NSS);
a circuit switched converter (CSDC) for establishing a circuit switched connection towards the first telecommunications system (NSS);
characterized in that:
said arrangement also comprises a common communications controller (CDCC) for establishing a connection between said converters (PSDC, CSDC) and said second telecommunications system (WAN), said common communications controller (CDCC) comprising a first and a second interface towards said first and second telecommunications systems (NSS, WAN), respectively; and
the first interface of the common communications controller (CDCC) is independent of its second interface.

2. An arrangement according to claim 1, characterized in that:
the packet switched converter (PSDC) and the circuit switched converter (CSDC) are substantially adapted only to convert the protocols used on said packet switched connection and said circuit switched connection, respectively, into a protocol which is used on a connection between the particular converter (PSDC, CSDC) and the common communications controller (CDCC); and
the common communications controller (CDCC) is adapted to perform substantially all the remaining functions to be performed in said arrangement.

3. An arrangement according to claim 1 or 2, characterized in that said common communications controller (CDCC) is adapted to perform functions which are selected from a set including: data compression and de-compression, routing of packets, security checks, access control, maintaining statistics, assembling billing data and transferring same to a billing system.

4. An arrangement according to claim 1, 2 or 3, characterized in that said common communications controller (CDCC) is connected to said packet switched converter (PSDC) and said circuit switched converter (CSDC) via a local area network (LAN).

5. An arrangement according to any one of claims 1 to 4, characterized in that said packet switched converter (PSDC) is operationally connected to a base station controller (BSC) of a mobile telecommunications system.

6. An arrangement according to any one of claims 1 to 5, characterized in that said circuit switched converter (CSDC) is operationally connected to a mobile switching centre (MSC) of a mobile telecommunications system.

7. A common communications controller (CDCC) for establishing connections between a first telecommunications system (NSS) and a second telecommunications system (WAN),
characterized in that said common communications controller (CDCC) comprises:
a first set of interface means to a circuit switched converter (CSDC) and to a packet switched converter (PSDC) for establishing a circuit switched and a packet switched connection, respectively, to said first telecommunications system (NSS);
a second set of interface means to said second telecommunications systems (WAN); wherein
said first set of interface means is independent of said second set of interface means.
